(19) United States
(12) Patent Application Publication
(10) Pub. No.: US 2022/0094042 A1
(43) Pub. Date: Mar. 24, 2022

(54) A Dipole Antenna Placed on a Wireless Headphone Casing

(71) Applicant: Innovation Sound Technology Co., LTD., Guangdong (CN)

(72) Inventors: Shunming YUEN, Guangdong (CN); Wai Yin MUNG, Guangdong (CN); Ka Ming WU, Guangdong (CN)

(21) Appl. No.: 16/610,990

(22) PCT Filed: Sep. 5, 2018
(86) PCT No.: PCT/CN2018/104172

§ 371 Date: Nov. 15, 2021

(30) Foreign Application Priority Data
Aug. 30, 2018 (CN) 201821413663.6

(51) Int. Cl. H01Q 1/27; H01Q 1/38; H01Q 1/36

(52) U.S. Cl. CPC H01Q 1/273; H01Q 1/364; H01Q 1/38

(57) ABSTRACT

The utility model discloses a dipole antenna placed on a wireless headphone casing, which comprises two metal conductors fixedly attached to the surface of the headphone casing. The metal conductors are connected to a matching circuit disposed on a PCB that is located in the headphone casing. The utility model presents a dipole antenna wherein the metal conductors are integrated with the earphone casing, and become a part of the earphone casing such that antenna signals are not blocked, and better receiving and transmitting signals are obtained. In addition, the metal conductors are not disposed on the PCB without occupying any space of the PCB, so that the PCB has more space for circuit design.

### FIELD OF THE INVENTION

The utility model relates to the field of wireless communication technologies, and in particular to a dipole antenna placed on a wireless headphone casing.

### BACKGROUND OF THE INVENTION

The dipole antenna is a resonant antenna, in which the current distribution exhibits a form of standing waves, and the wavelength of standing waves is exactly that of electromagnetic waves generated or received by the antenna. As a consequence, when making a dipole antenna, the length of the antenna is determined by its operating wavelength. The most common dipole antenna is a half-wave antenna whose total length is approximately half the operating wavelength. Shown in FIG. 1 is a half-wave antenna composed of straight conductors, and there are other kinds of dipole antennas as well.

Dipole antennas are often used on wireless headphones, currently hidden on a PCB in a headphone casing. In the use, it has the opportunity to affect antenna characteristics, not only easily affecting the receiving signals of a wireless headphone, but also adversely affecting the quality of the reception and transmission of antenna signals. Moreover, a headphone antenna occupies most of the space on a PCB.

### Content of the Utility Model

The utility model aims to provide a dipole antenna placed on a wireless headphone casing to solve the problem brought up above in the background technology.

To achieve the above object, the present invention provides the following technical schemes:

A dipole antenna placed on a wireless headphone casing, which comprises two metal conductors fixedly attached to the surface of a headphone casing, and connected to a matching circuit disposed on a PCB that is located in a headphone casing.

As a further scheme of the utility model, the metal conductors are made of metallic copper.

Compared with the prior art, the beneficial effects of the utility model are as follows:

The utility model presents a dipole antenna wherein metal conductors are integrated with the earphone casing, and become a part of the earphone casing such that antenna signals are not blocked, and better receiving and transmitting signals are obtained. In addition, the metal conductor is not disposed on the PCB without occupying any space of the PCB, so that the PCB has more space for circuit design.

### BRIEF INTRODUCTION OF THE DRAWINGS

FIG. 1 is a structural schematic diagram of a dipole antenna.

FIG. 2 is a structural schematic diagram of the utility model.

FIG. 3 is a structural schematic diagram of the side view of FIG. 2.

FIG. 4 is a schematic diagram showing the connection principle of a dipole antenna in the utility model.

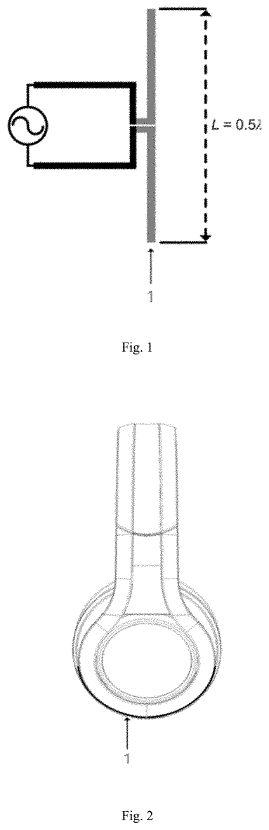

### DETAILED EMBODIMENT

The technical scheme in the embodiments of the utility model will be clearly and completely described as follows with reference to the accompanying drawings. Apparently, the described embodiments are only a part of that of the utility model, and not all of them. All other embodiments obtained by those skilled in the art based on the embodiments of the utility model without making creative efforts shall fall within the scope of protection of the present invention.

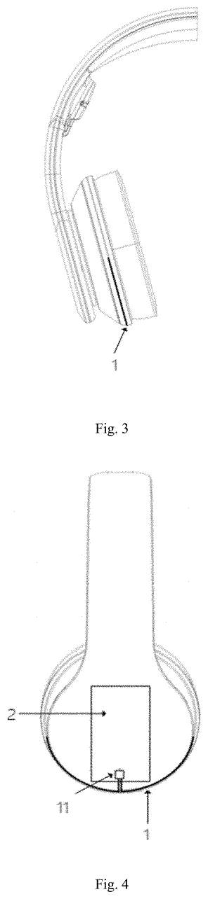

Refer to FIGS. 2 to 4 for a dipole antenna, as proposed in the embodiments of the present invention, disposed on a wireless earphone housing and comprising two metal conductors 1. The metal conductor 1 may employ a flexible metal, such as metallic copper, which shall be bent to a certain extent, adapt to the shape of the headphone casing, and fixedly attached to the surface of a headphone casing. The metal conductors 1 are connected to a matching circuit (11) disposed on a PCB (2) that is located in a headphone casing. Thus, the metal conductors 1 are integrated with the headphone casing to become a part of the headphone casing, antenna signals are not blocked, and better receiving and transmitting signals are obtained. Further, the metal conductors 1 are not disposed on the PCB 2 without occupying any space of the PCB 2, so that the PCB 2 has more space for circuit design.

For those skilled in the art, apparently the utility model is not limited to the details given in the above exemplary embodiments. The utility model can be embodied in other specific forms without departing from the spirit or essential characteristics of the utility model. Therefore, the embodiments shall be considered as exemplary and unrestricted in any way. The scope of the utility model is defined by the appended claims rather than the above description. Hence, all changes intended to come within the meaning and range of equivalent elements of the claims shall be included within the utility model. Any marks on drawings to the Claims shall not be construed as limiting the Claims involved.

Furthermore, it shall be understood that although the Specification is described in terms of embodiments, not every embodiment includes only one independent technical scheme. The description style in the Specification is for clarity only. Those skilled in the art shall take the Specification as a whole. The technical schemes in various embodiments may also be combined as appropriate to form other embodiments that c be understood by those skilled in the art.

1. A dipole antenna placed on a wireless headphone casing, which comprises two metal conductors fixedly attached to the surface of the headphone casing, and connected to a matching circuit disposed on a PCB that is located in the headphone casing.

2. A dipole antenna disposed in a wireless headphone casing according to claim 1, wherein the metal conductors are made of metallic copper.

3. A dipole antenna disposed in a wireless headphone casing according to claim 1, wherein the antenna is subject to plated surface treatment.

4. A dipole antenna placed on the casing of a wireless headphone according to claim 1, wherein the metal conductors are made of metallic copper, and can also be oil sprayed on the surface.
